(19) United States
(12) Patent Application Publication
(10) Pub. No.: US 2012/0029907 A1
(43) Pub. Date: Feb. 2, 2012

(54) myMedicalpen

(76) Inventors: Angela Loggins, Richardson, TX (US); Tamara S. Loggins, Richardson, TX (US)

(21) Appl. No.: 12/981,612

(22) Filed: Dec. 30, 2010

Related U.S. Application Data
(60) Provisional application No. 61/367,922, filed on Jul. 27, 2010.

(51) Int. Cl. G06F 17/27; G10L 21/06

(52) U.S. Cl. 704/9; 704/276; 704/E21.019

(57) ABSTRACT

A digital pen designed to assist users in spelling words as they write. The invention is an electronic pen with a speaker located near the top of the device. A microphone may be located directly under the speaker in the form of a small screened concave or convex aperture. A switch on the back of the pen allows the user to choose between three settings: Medical Dictionary (D), Off (O), and Prescription Drug List (P). The device works by the user speaking the desired word into the microphone. The word will then appear on the illuminated digital display screen which lights up. The pen asks the user to confirm or deny the displayed word. The user says “yes” or “no” into the microphone. If denied, the pen displays another word until the correct word is located. Once confirmed, the pen will audibly and visibly spell the word one letter at a time as the user writes. The pen may be switched to the prescription drug list mode as needed.

### CROSS-REFERENCE TO RELATED APPLICATION

The present application is related to and claims priority from prior provisional application Ser. No. 61/367,922, filed Jul. 27, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of pens and more specifically relates to a digital electronic pen device that aids a user in spelling words and locating synonyms/antonyms for words as they write.

2. Description of the Related Art

Pens are a common writing instrument for placing text on surfaces such as paper. Other versions of pens are also available. Digital pens are an input device which captures the handwriting or brush strokes of a user, and digitizes them so that they may be downloaded to a computer and displayed on its monitor. The data can then be interpreted by handwriting software (OCR) and used in different applications or just as graphics. A digital pen is generally larger and has more features than a stylus. Digital pens typically contain internal electronics, and have features such as touch sensitivity, input buttons, memory, Bluetooth transmission capabilities, and electronic erasers. These pens must be used in combination with another computing device such as a computer.

Individuals commonly find themselves in a situation where they are writing a note or filling out a form and don't know how to spell a word. Sometimes it is a matter of simply forgetting how to spell the word. Most individuals do not have constant access to a medical dictionary and/or prescription drug book. They may have to ask those around them how to spell the word, or they may have to guess. Many people are embarrassed when they misspell or misuse a word.

When computing, a spell checker (or spell check) may be used as an application program that flags words in a document that may not be spelled correctly. Spell checkers may be stand-alone capable of operating on a block of text, or as part of a larger application, such as a word processor, email client, electronic medical dictionary, or search engine. Simple spell checkers operate on individual words by comparing each of them against the contents of a medical dictionary. If the word is not found it is considered to be an error, and an attempt may be made to suggest a word that was likely to have been intended. One such suggestion algorithm is to list those words in the medical dictionary having a small Levenshtein distance from the original word. When a word which is not within the medical dictionary is encountered most spell checkers provide an option to add that word to a list of known exceptions that should not be flagged. This too may culminate in errors for the user in his/her documents. A spell check is typically found on computer writing programs such as Microsoft Word®. Unfortunately, a user is not always in the vicinity of a computer with a writing program readily available when requiring the assistance of a spell check. Therefore, a need exists for a more convenient and portable method of spell checking when a user writes on a surface such as paper.

Various attempts have been made to solve the above-mentioned problems such as those found in U.S. Pat. Nos. 2005/0125228, D500,518, 2007/0016420, 7,404,143, 2005/0125217, and 7,012,595. This prior art is representative of electronic devices with spell check capabilities. None of the above inventions and patents, taken either singly or in combination, is seen to describe the invention as claimed.

Ideally, a digital pen with spell check device should be convenient and user-friendly and yet, would operate reliably and be manufactured at a modest expense. Thus, a need exists for a reliable myMedicalpen to aid a user with spelling a designated word and to avoid the above-mentioned problems.

### BRIEF SUMMARY OF THE INVENTION

In view of the foregoing disadvantages inherent in the known digital electronic pen device art, the present invention provides a novel myMedicalpen. The general purpose of the present invention, which will be described subsequently in greater detail, is to assist users in spelling words and locating synonyms/antonyms for words when needed, especially in remote locations. The product comprises an electronic pen that has spell check capabilities, as well as an integrated prescription drug list. The pen includes a microphone that allows the user to request the spelling of a specific word. The tool may then audibly and digitally recite the spelling of the word as the user writes with the pen as per normal.

The present digital electronic pen disclosed herein preferably comprises the following components: a cap, a removable pen tip, a replaceable ink supply holder, an ink transfer mechanism that may or may not be comprised of a retractable ink dispensing tip, a digital display screen comprising an illuminator and a battery indicator level, a microphone, at least one speaker, a switch, a charging/uploading port, an integrated circuit having a chip, a memory storage device comprising of a medical dictionary/prescription drug list, a charging/uploading power cord and a sleeve. The replaceable ink supply holder contains writing fluid that is transferable to a surface using the ink transfer mechanism thereby allowing a user to write on the preferred surface. The ink transfer mechanism may or may not comprise a retractable ink dispensing tip.

The digital electronic pen has the capabilities of interfacing with software (i.e. may include several versions of updates in the future) in which new data may be uploaded, a different language can be selected from the software version, set pen's volume, allow troubleshooting or the pen's battery may be charged via a USB port. The USB port may also interface with an adapter that allows the pen to be charged via an AC wall electrical outlet.

Additionally a cap may be used to protect the ink dispensing tip during non-use periods. A switch permits the user to control power to the digital electronic pen so as to conserve the power supply during non-use periods. A pen sleeve stores the digital electronic pen during non-use periods. A charging/uploading data port permits the digital electronic pen to be charged for in-use periods or uploads the latest version of medical dictionary/prescription drug list software and allows troubleshooting to occur as needed. A digital display screen is also found on the present invention comprising an illuminator and a battery indicator level.

Further, a microphone is included to act as a transducer to convert an input audible signal comprising at least one spoken word into a first electrical signal. The integrated circuit preferably receives the first electrical signal, deciphers the first electronic signal from the incorporated memory storage device and relays at least one responsive second electrical signal to the speaker. The responsive second electrical signal comprises at least one audibly spelled word, outputted letter by letter for at least one audible output to aid the user in correctly spelling the desired word(s). The responsive second electrical signal may also be text-displayed on the digital display screen simultaneously.

A kit is embodied herein for the myMedicalpen comprising: a digital electronic pen; at least one integrated circuit having a chip; at least one pen sleeve; at least one replaceable ink supply holder; a cap; a power cord to charge or upload data to the pen with AC adapter power source; and a set of user instructions.

In accordance with the embodiments of the present invention a preferred method of use is disclosed herein comprising: at least one user verbally audiblizing an inquiry word into a microphone of a digital electronic pen; next the user confirms or denies if the response to the inquiry word is correct, thereby allowing user-input, and finally the digital electronic pen audibly and visibly relays a response to the inquiry word by spelling out the inquiry word letter by letter both audibly and visually.

The present invention, myMedicalpen, holds significant improvements and serves as a spell check pen available in many languages to accommodate any global language demands. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, myMedicalpen device constructed and operative according to the teachings of the present invention.

FIG. 1 shows myMedicalpen in an ‘in-use’ condition according to an embodiment of the present invention.

FIG. 2a shows a front perspective view illustrating a speaker, a microphone and the illuminated digital display with the battery indicator on the myMedicalpen according to an embodiment of the present invention.

FIG. 2b shows a back perspective view illustrating a charging/uploading port and a switch having three positions [Medical Dictionary (D)—Off (O)—Prescription Drug List (P)].

FIG. 3 is a perspective view illustrating a medical dictionary mode with spell check capabilities of the myMedicalpen according to an embodiment of the present invention of FIG. 1.

FIG. 4 is a perspective view illustrating a prescription drug list mode of myMedicalpen according to an embodiment of the present invention of FIG. 1.

FIG. 5. is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a pen and more specifically relates to a digital electronic pen device that aids a user in spelling words and locating synonyms/antonyms for words as they write.

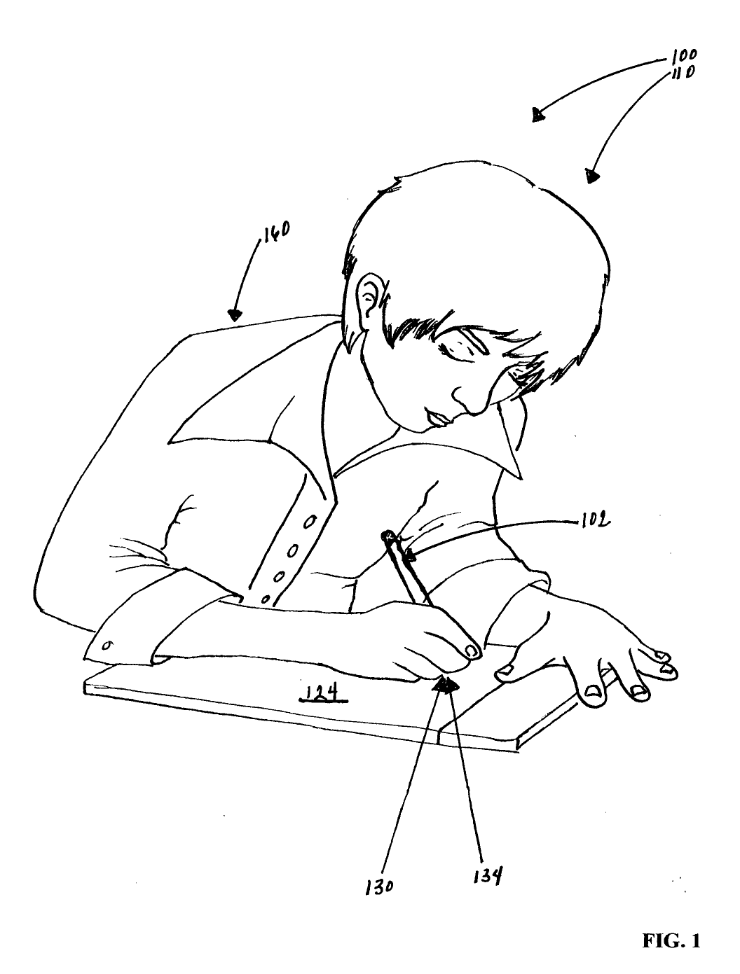

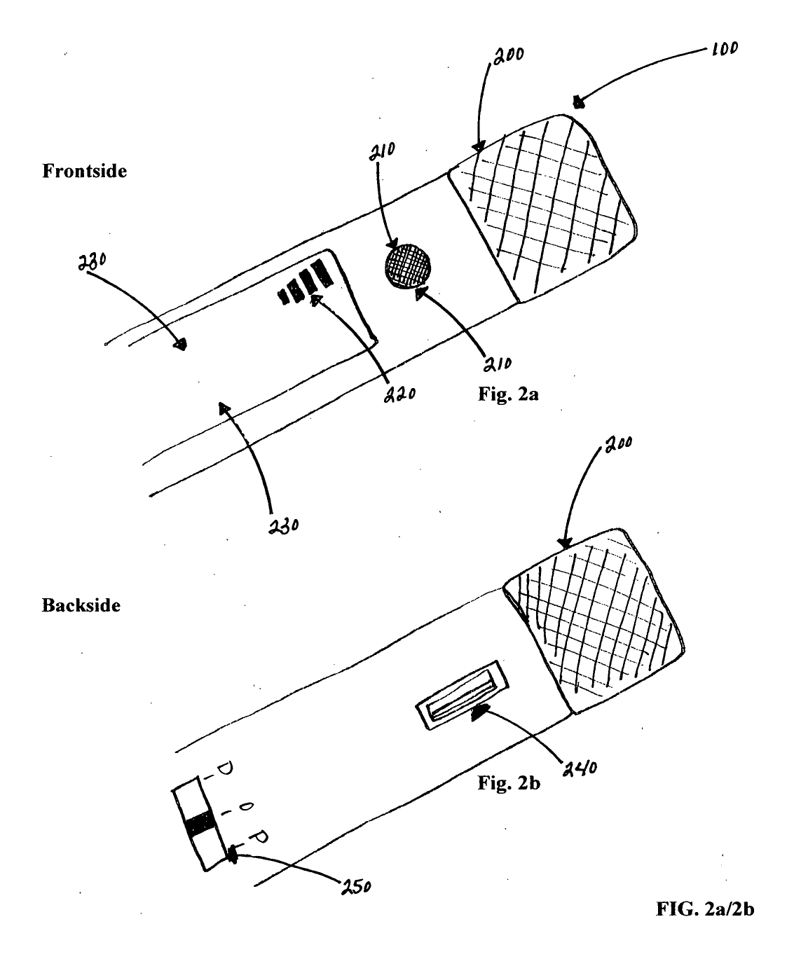

Referring now to FIG. 1 showing a perspective view of myMedicalpen 100 in ‘in-use’ condition 110 according to an embodiment of the present invention. MyMedicalpen 100 comprises digital electronic pen 102. Digital electronic pen 102 is preferably designed to assist user 160 in spelling words and conveniently locating synonyms/antonyms for words when needed. Digital electronic pen 102 preferably has spell check capabilities as well as an integrated prescription drug list. Digital electronic pen 102 comprises an integrated circuit for the electronic storage/accessing of both the medical dictionary and the prescription drug list which will be described further in FIGS. 2-4.

Digital electronic pen 102 comprises (removable) ink supply holder 120 and ink transfer mechanism 130. Ink supply holder 120 contains writing fluid. Writing fluid comprises ink which is transferable to surface 124 using ink transfer mechanism 130 (roller ball or other). Surface 124 may include but is not limited to paper or other suitable surface. Ink transfer mechanism 130 permits user 160 to transfer ink to write on surface 124. Ink supply holder 120 is preferably replaceable. Therefore, when the writing fluid such as ink is running low or completely runs out, ink supply holder 120 may be replaced. In this way the present invention is cost-effective in use over an extended duration. To replace ink supply holder 120, removable pen tip 106 of digital electronic pen 102 may be unscrewed to allow user 160 to insert a new ink supply holder 120. It should be appreciated that other replacement may be employed and still be considered within the scope of the present invention.

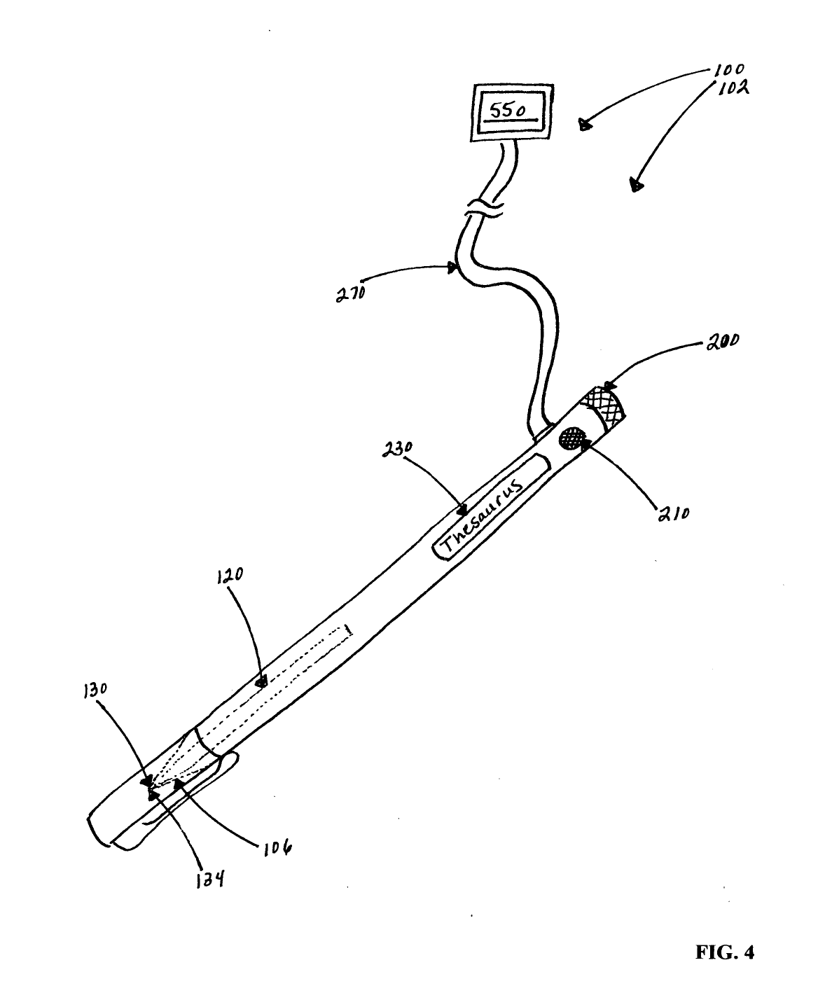

Ink transfer mechanism further comprises ink dispensing tip 134. Ink dispensing tip 134 may or may not be retractable by rotating bottom portion of pen. Ink dispensing tip 134 comprises the portion of digital electronic pen 102 that comes in contact with surface 124 when user 160 presses downwardly to initiate writing a letter to form text writing. Removable pen tip 106 of digital electronic pen 102 may or may not be rotated to retract the ink supply holder 120 into the ink dispensing tip 134 in FIG. 4.

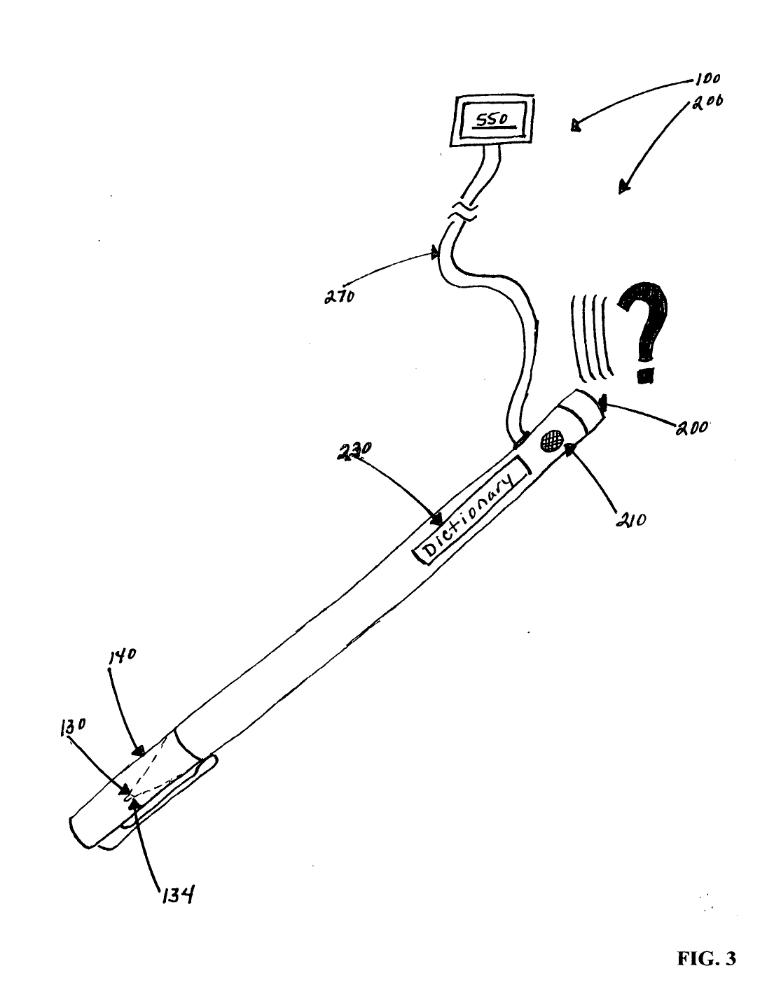

In the present embodiment, cap 140 may be used in conjunction with digital electronic pen 102 to protect ink dispensing tip 134 and ink transfer mechanism 130 during non-use periods as shown in FIG. 3. Non-use periods within this disclosure include times when user 160 is not using pressing downwardly on ink dispensing tip 134 or ink transfer mechanism 130 onto surface 124. In this way, cap 140 acts as a protective cover for ink dispensing tip 134 and ink transfer mechanism 130. Cap 140 is removable and allows user 160 to use pen that comes in contact with surface 124. A pen sleeve may be used to store digital electronic pen 102 when not in use. The pen sleeve acts as a second barrier for preventing unwanted scratches or damage to myMedicalpen 100. Further, the pen sleeve protects the integrity of the present invention and helps display it in a desirable fashion.

Digital electronic pen 102 may be manufactured with plastic, metal, or other suitable material(s). Further, digital electronic pen 102 may be available in a variety of colors and designs to accommodate user-chosen preferences.

Referring now to FIGS. 2-4, showing perspective views illustrating digital electronic pen 102 according to an embodiment of the present invention.

Front view of the digital electronic pen 102 preferably further comprises speaker 200 located on the top portion of the pen, a microphone 210 directly centered beneath the speaker, a battery indicator level 220, a digital display screen 230 as sown in FIG. 2a. Back view of the digital electronic pen 102 preferably further comprises speaker 200 located on the top portion of the pen, a charging/uploading port 240, and a medical dictionary/off/prescription drug list (D-O-P) switch 250 as shown in FIG. 2b. Speaker 200 is preferably located on the top portion of digital electronic pen 102 as shown best in FIGS. 2a and 2b. Microphone 210 may be located directly centered beneath the speaker 200 in the form of a small screened concave or convex aperture. Speaker 200 is located on upper portion (proximate user's face/mouth) of digital electronic pen 102 also shown best in FIGS. 2a and 2b.

Microphone 210 comprises an acoustic-to-electric transducer or sensor that converts sound into an electrical signal. A transducer as described herein comprises a device that converts one type of energy to another. The conversion can be to/from electrical (as s alluded to in the present embodiments), however electro-mechanical, electromagnetic, photonic, photovoltaic, or any other form of energy may also be considered potential equivalents.

Microphone 210 on digital pen 102 preferably acts as a transducer to convert an input audible signal into a first electrical signal. The input audible signal comprises at least one spoken word. An integrated circuit preferably receives the first electrical signal. The integrated circuit may comprise or be in combination with at least one chip. The integrated circuit receives the first electrical signal, deciphers the first electronic signal from a memory storage device and relays at least one responsive second electrical signal to speaker 200. Speaker 200 comprises at least one audibly spelled word, outputted letter by letter for at least one audible output. The responsive second electrical signal may also be text-displayed on digital display screen 230 simultaneously. In this way the present invention provides a visual and audible means for service. The memory storage device may comprise a medical dictionary as shown in FIG. 3. Further, memory storage device may comprise a prescription drug list as shown in FIG. 4.

Digital display screen 230 is preferably located underneath microphone 210. Digital display screen 230 comprises an illuminator to light up designated text for ease of viewing during poor light conditions. Digital display screen 230 has large enough dimensions to display entire words such as medical dictionary or prescription drug list for example. In certain embodiments the text may scroll for spelling of larger words. Further, digital display screen 230 includes battery indicator level 220. When battery indicator level 220 becomes low, digital electronic pen 102 may be charged via a charging port located on a posterior region of digital electronic pen 102. Digital electronic pen 102 preferably comprises a rechargeable battery located in the interior for the recharging of the device. Charging/uploading new versions of software to the digital electronic pen 102 via the charging/uploading port may be completed either by a USB cord or by connecting to an alternate AC power source.

To use digital electronic pen 102, user 160 speaks the desired word into microphone 210. The word will preferably then appear on digital display screen 230. Digital electronic pen 102 will preferably ask user 160 to confirm or deny via an input means that the correct user-selected word is displayed. User 160 may then say “yes” or “no” into microphone 210. If denied, digital electronic pen 102 preferably will display another user-specified word until the correct word is located. Once confirmed, digital electronic pen 102 will preferably audibly via speaker 200 and visibly via digital display screen 230 spell the word as user 160 writes.

Referring now to FIG. 4 showing a perspective view illustrating a prescription drug list mode of myMedicalpen 100 according to an embodiment of the present invention of FIG. 1. Digital electronic pen 102 of myMedicalpen 100 comprises switch 250. Switch 250 is located on the posterior side of digital electronic pen 102. Switch 250 permits user 160 to control power to digital electronic pen 102 by turning the device off from either medical dictionary mode or prescription drug list mode. Further, switch 250 preferably permits user 160 to choose between three settings: medical dictionary (D), off (O), and prescription drug list (P) modes. As shown in FIG. 4, digital electronic pen 102 is in prescription drug list mode. The electronic prescription drug list (stored in the memory of the device) outputs/lists words grouped together according to similarity of meaning (containing synonyms and sometimes antonyms).

When user 160 flips switch 250 to prescription drug list mode, user 160 speaks the desired word into microphone 210. Synonyms (and if desired antonyms) for the user-selected word will then appear on digital display screen 230. Digital electronic pen 102 will preferably ask user 160 to confirm or deny that the correct synonym/antonym for the user-selected word is displayed. User 160 will then say “yes” or “no” into microphone 210. If denied, digital electronic pen 102 preferably will display another synonym/antonym until the correct synonym/antonym for the user-selected word is located. Once confirmed, digital electronic pen 102 will preferably audibly via speaker 200 and visibly via digital display screen 230 spell the word as user 160 writes.

Back view of the digital electronic pen 102 preferably comprises of a battery/upload port 240 that allows user 160 to charge digital electronic pen 102 via USB cord which may include a charge/upload power cord 270 with AC adapter power source 550. Furthermore, digital electronic pen 102 may have newer versions of software uploaded to the pen, may allow user 160 to select between global languages (such as Chinese, Spanish, French, German, Russian, etc. . . . ), may allow volume to be set or allow troubleshooting of the device.

MyMedicalpen 100 according to an embodiment of the present invention of FIGS. 1-4 may comprise kit 440. Kit 440 may comprise the following parts: digital electronic pen 102; at least one integrated circuit having a chip; at least one pen sleeve; at least one replaceable ink supply holder 120; cap 140; a power cord 270 with AC adapter power source 550 to charge/upload data to the digital electronic pen 102, and a set of user instructions.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately such as replaceable ink supply holders or pen sleeves, etc., may be sufficient.

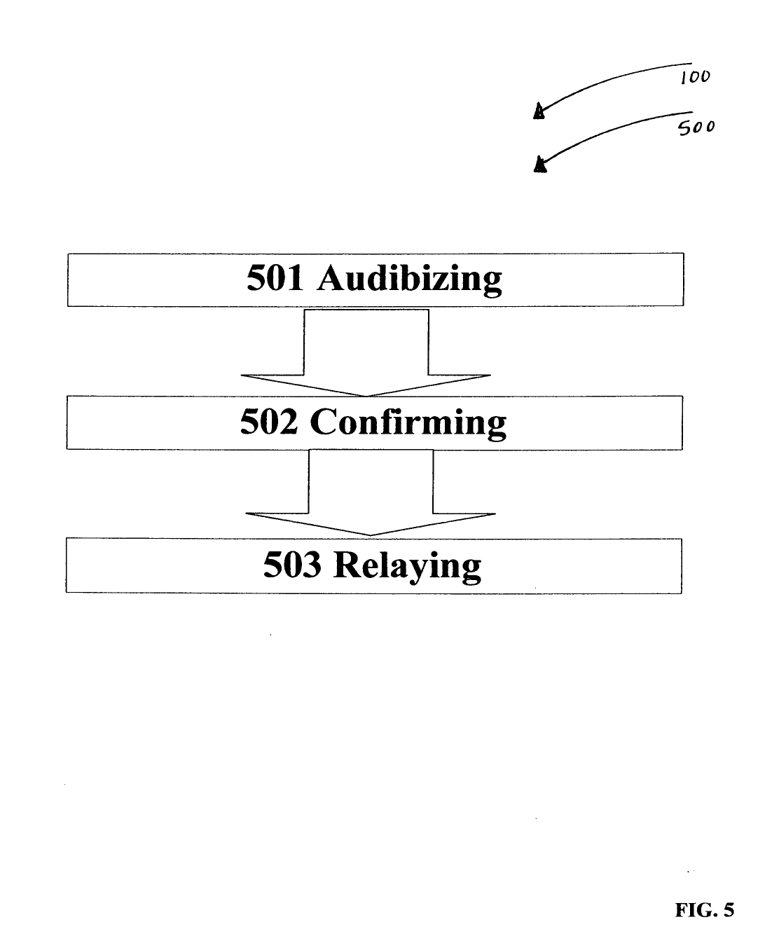

Referring now to FIG. 5. showing a flowchart illustrating method of use 500 according to an embodiment of the present invention of FIGS. 1-5. A method of using digital electronic pen device 102 comprising the steps of: step one 501 at least one user 160 verbally audiblizing an inquiry word into microphone 210 of a digital electronic pen 102; step two 502 user 160 confirming or denying if the response to the inquiry word is correct, and step three 503 digital electronic pen 102 audibly and visibly relaying a response to the inquiry word by spelling out the inquiry word letter by letter.

It should be noted that the steps described in the method of use may or may not be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A digital electronic pen comprising:
a cap;
a removable pen tip;
a replaceable ink supply holder;
an ink transfer mechanism that may or may not be comprised of a retractable ink dispensing tip;
a digital display screen comprising an illuminator and a battery indicator level;
a microphone;
at least one speaker;
a switch;
a charging/uploading port;
an integrated circuit having a chip;
a memory storage device comprising of a medical dictionary/prescription drug list;
a charging/uploading power cord with AC power source;
a sleeve
wherein said ink supply holder contains writing fluid that is transferable to a surface using said ink transfer mechanism thereby allowing at least one user to write on said surface;
wherein said microphone acts as a transducer to convert an input audible signal into a first electrical signal;
wherein said integrated circuit receives said first electrical signal, deciphers said first electronic signal from said memory storage device and relays at least one responsive second electrical signal to said at least one speaker for at least one audible output;
wherein said responsive second electrical signal is also text-displayed on said digital display screen simultaneously as one audible output on said speaker; and
wherein said digital electronic pen may be charged or upload of new data via charge/upload data power cord with AC power source.

2. The digital electronic pen of claim 1 wherein said ink supply holder is replaceable.

3. The digital electronic pen of claim 1 wherein said ink transfer mechanism comprises an ink dispensing tip.

4. The digital electronic pen of claim 3 further comprises a cap to protect said ink dispensing tip during non-use periods.

5. The digital electronic pen of claim 3 wherein said ink dispensing tip may or may not be retractable.

6. The digital electronic pen of claim 1 wherein said integrated circuit comprises at least one integrated circuit have a chip.

7. The digital electronic pen of claim 1 wherein said input audible signal comprises at least one spoken word.

8. The digital electronic pen of claim 7 wherein said at least one responsive second electrical signal to said microphone for at least one audible output from said speaker comprises at least one audibly spelled word and another responsive third electrical signal in which one visibly output from said illuminated digital display, outputted letter by letter simultaneously.

9. The digital electronic pen of claim 1 wherein said memory storage device comprises a medical dictionary.

10. The digital electronic pen of claim 1 wherein said memory storage device comprises a prescription drug list.

11. The digital electronic pen of claim 1 further comprising a switch.

12. The digital electronic pen of claim 11 wherein said switch permits said user to control power to said digital electronic pen via switching from off to medical dictionary or from off to prescription drug list.

13. The digital electronic pen of claim 1 wherein said digital display screen further comprising an illuminator.

14. The digital electronic pen of claim 13 wherein said digital electronic pen further comprises a battery indicator level located in the top right hand portion of the illuminated digital display.

15. The digital electronic pen of claim 1 further comprising at least one charging port to permit said digital electronic pen to be charged via a USB cord.

16. The digital electronic pen of claim 1 further comprises at least one charging/uploading port to permit said digital electronic pen to be charged via a connector connected from the USB cord to an AC power source or allows digital electronic pen to upload new versions of software, select global languages, set pen volume or troubleshoot the pen.

17. The digital electronic pen of claim 1 wherein said digital electronic pen further comprises at least one pen sleeve to store said digital electronic pen when not in use.

18. A digital electronic pen comprising:
a cap;
a removable pen tip;
a replaceable ink supply holder;
an ink transfer mechanism that may or may not be comprised of a retractable ink dispensing tip;
a digital display screen comprising an illuminator and a battery indicator level;
a microphone;
at least one speaker;
a switch;
a charging/uploading port;
an integrated circuit having a chip;
a memory storage device comprising of a medical dictionary/prescription drug list;
a charging/uploading power cord with AC power source;
a sleeve
wherein said replaceable ink supply holder contains writing fluid that is transferable to a surface using said ink transfer mechanism thereby allowing at least one user to write on said surface;
wherein said cap protects said ink dispensing tip during non-use periods;
wherein said pen sleeve stores said digital electronic pen during non-use periods;
wherein said charging/uploading port permits said digital electronic pen to be charged or allows uploading of data and/or troubleshooting;
wherein said switch permits said user to control power to said digital electronic pen;
wherein said microphone acts as a transducer to convert an input audible signal comprising at least one spoken word into a first electrical signal;
wherein said integrated circuit receives said first electrical signal, deciphers said first electronic signal from said memory storage device and relays at least one responsive second electrical signal to said speaker comprises at least one audibly spelled word, outputted letter by letter for at least one audible output; and
wherein said responsive second electrical signal is also simultaneously text-displayed on said digital display screen.

19. The digital electronic pen of claim 18 further comprising a kit including: said digital electronic pen; said at least one integrated circuit having a chip; said at least one pen sleeve; said at least one replaceable ink supply holder; said cap; a power cord with AC adapter power source to charge or upload data to the pen; and a set of user instructions.

20. A method of using a digital electronic pen system comprising the steps of:
at least one user verbally audiblizing an inquiry word into a microphone of a digital electronic pen;
said user confirming or denying if said response to said inquiry word is correct, and
said digital electronic pen audibly and visibly relaying a response to said inquiry word by spelling out said inquiry word letter by letter.
